(19) United States
(12) Patent Application Publication
(10) Pub. No.: US 2005/0147048 A1
(43) Pub. Date: Jul. 7, 2005

(54) Low cost test option using redundant logic

(76) Inventor: Steven L. Haehn, Fort Collins, CO (US)

Correspondence Address: LSI LOGIC CORPORATION, 1621 BARBER LANE, MS: D-106, MILPITAS, CA, 95035, US

(21) Appl. No.: 10/752,942

(22) Filed: Jan. 7, 2004

(51) Int. Cl. H04L 1/00

(52) U.S. Cl. 370/241

(57) ABSTRACT

A test scheme which includes a drive circuit connected to a plurality of IP cores (such as memory blocks, processors (i.e., ARM, MIPS, ZSP) or special types of IO's (i.e., Gigablaze, Hyperphi)). The drive circuit is configured to simultaneously send the same input stimuli to each of the IP cores. Outputs of the IP cores are run through a comparator, and the comparator is configured to identify when the outputs from the IP cores are not identical.

### BACKGROUND

The present invention generally relates to methods and apparatuses for testing integrated circuits, and more specifically relates to a method and apparatus for testing an integrated circuit using redundant logic.

Test cost versus outgoing quality is an ongoing challenge with regard to highly integrated technologies. In other words, while extensive testing of highly integrated testing assures a highly quality product, extensive testing is expensive.

There are two primary ways to address fault coverage when testing an integrated circuit. The device can be tested using external hardware to stimulate and observe the response of the device, or the device can be tested using internal circuitry to stimulate and observe the response of the circuit. A disadvantage of using external hardware to perform the testing is the associated cost of the hardware and software necessary to support the model. Disadvantages of using internal circuitry to perform the testing include the silicon overhead, design integration and the difficulty in obtaining high fault coverage from a pseudo random approach.

Generally, current test solutions are built on a combination of these two principles. Regardless, as shown in FIG. 1, if four IP cores 10 are to be tested, current methodology provides that all four of the IP cores are tested independently of each other—i.e., using a pattern stimulus source 12, which could be external or internal, to provide a stimulus to each of the IP cores 10, and a device 14 to perform capture checking on the outputs of the IP cores to determine if the overall circuit is free of manufacturing defects.

### OBJECTS AND SUMMARY

An object of an embodiment of the present invention is to provide a low cost test solution for technologies that incorporate redundant logic.

Another object of an embodiment of the present invention is to provide a test scheme which targets Rapid Chip technology but could be applied to any ASIC/ASSP process that uses a high percentage of redundant logic.

Briefly, and in accordance with at least one of the foregoing objects, an embodiment of the present invention provides a test scheme which includes a drive circuit connected to a plurality of IP cores (such as memory blocks, processors (i.e., ARM, MIPS, ZSP) or special types of IO's (i.e., Gigablaze, Hyperphi)). The drive circuit is configured to simultaneously send the same input stimuli to each of the IP cores. Outputs of the IP cores are run through a comparator, and the comparator is configured to identify when the outputs from the IP cores are not identical.

### BRIEF DESCRIPTION OF THE DRAWINGS

The organization and manner of the structure and operation of the invention, together with further objects and advantages thereof, may best be understood by reference to the following description, taken in connection with the accompanying drawing, wherein:

FIG. 1 is an illustration of how IP cores are generally currently tested;

FIG. 2 is an illustration of a test approach which is accordance with an embodiment of the present invention, wherein a parallel drive circuit is followed by a comparator that is used to test repetitive logic blocks; and

FIG. 3 is a flow chart of a method which is in accordance with an embodiment of the present invention.

### DESCRIPTION

While the invention may be susceptible to embodiment in different forms, there is shown in the drawings, and herein will be described in detail, a specific embodiment with the understanding that the present disclosure is to be considered an exemplification of the principles of the invention, and is not intended to limit the invention to that as illustrated and described herein.

Programmable/configurable technologies such as Rapid Chip rely on a base configuration that may include several different types of standard IP cores such as memory blocks, processors (ARM, MIPS, ZSP), or special types of IO's (Gigablaze, Hyperphi). To save money, the base configurations are built using a standard number of IP blocks. The present invention realizes that there are plural occurrences of identical logic in the circuit, and the output response of these plural occurrences could be used to determine correct functional operation of the overall circuit.

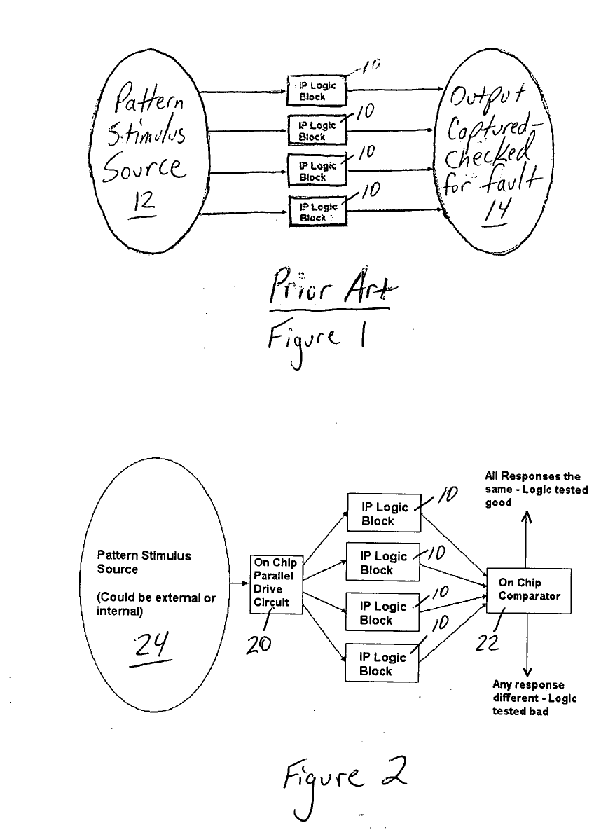

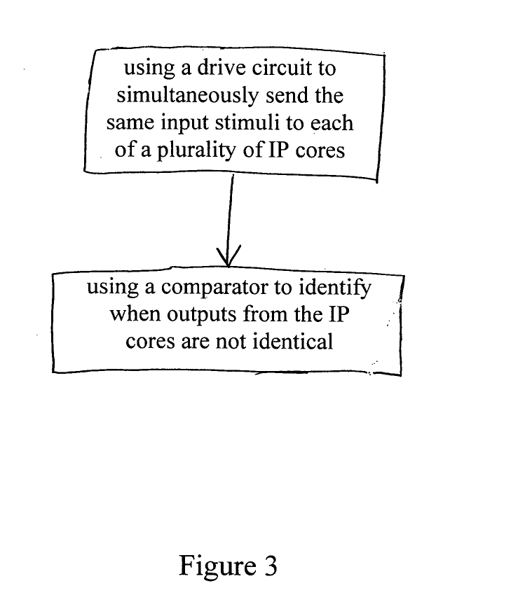

FIG. 2 illustrates a test approach which is accordance with an embodiment of the present invention. FIG. 3 is a self-explanatory flow chart which focuses on the test method. In the example shown in FIG. 2, the design provides a base configuration that includes four identical IP cores 10. While FIG. 2 illustrates four IP cores, the principle could be applied to any number of repeating logic blocks. The IP cores 10 can be, for example, memory blocks, processors (ARM, MIPS, ZSP), or special types of IO's (Gigablaze, Hyperphi). As described above, under current test methodologies (illustrated in FIG. 1), all four IP cores 10 would be tested independently of each other to determine if the overall circuit is free of manufacturing defects. In contrast, in the test scheme shown in FIG. 2, the four IP cores are effectively tied in parallel so that they receive the same input stimulus at the same time. Specifically, a parallel drive circuit 20 is connected to the inputs of the IP cores 10, and is configured to simultaneously send the same input stimuli to each of the IP cores 10. The drive circuit 20 and the comparator circuit 22 may be configured to provide diagnostic capabilities.

Outputs of the IP cores are connected to comparator circuitry 22, such as a simple comparator, which is configured to identify when the outputs from the IP cores are not identical (i.e., flag any stimulus that does not generate identical outputs). If the drive circuit 20 is configured to provide diagnostic capabilities, comparator circuitry 22 would need to be able to identify which IP core(s) 10 caused the fail.

The test scheme may be expanded to include a linear feedback shift register 24 (external or internal) which is configured to provide pseudo random pattern generation. Under this mode, there is still a significant advantage over LBIST type solutions since the simple comparator on the output side would eliminate the need for including a MISR (Multiple-Input Signature Register).

Advantages of the invention include reduced test cost by reducing the external and internal design requirements to achieve equivalent fault coverage. Design cost is also reduced since only one logic block needs to be fault simulated. Due to the redundant nature of the test, all equivalent logic blocks will have the same fault coverage.

The present invention provides a low cost test solution for technologies that incorporate redundant logic, as well as provides a test scheme which targets Rapid Chip technology, but which could be applied to any ASIC/ASSP process that uses a high percentage of redundant logic.

While an embodiment of the present invention is shown and described, it is envisioned that those skilled in the art may devise various modifications of the present invention without departing from the spirit and scope of the appended claims.

1. A test structure comprising: a plurality of IP cores, each of the IP cores having an input and an output; a drive circuit connected to the inputs of the IP cores and configured to simultaneously send the same input stimuli to each of the IP cores; a comparator connected to the outputs of the IP cores, wherein the comparator is configured to identify when the outputs from the IP cores are not identical.

2. The test structure as recited in claim 1, wherein the IP cores comprise memory blocks or processors.

3. The test structure as recited in claim 2, wherein the IP cores comprise ARM, MIPS or ZSP processors.

4. The test structure as recited in claim 1, wherein the IP cores comprise Gigablaze or Hyperphi IO devices.

5. The test structure as recited in claim 1, wherein each of the IP cores are identical.

6. The test structure as recited in claim 1, wherein said plurality of IP cores comprises four IP cores.

7. The test structure as recited in claim 1, wherein said comparator is configured to provide diagnostic capabilities and is configured to identify which of the IP cores caused a fail.

8. The test structure as recited in claim 1, further comprising a device connected to said drive circuit and configured to provide pseudo random pattern generation.

9. The test structure as recited in claim 8, wherein said device comprises a linear feedback shift register.

10. The test structure as recited in claim 9, wherein the test structure does not include a Multiple-Input Signature Register.

11. A method of testing a plurality of IP cores comprising: using a drive circuit to simultaneously send the same input stimuli to each of the IP cores; and using a comparator to identify when outputs from the IP cores are not identical.

12. The method as recited in claim 11, wherein the step of using a comparator comprises using a comparator which provides diagnostic capabilities and is configured to identify which of the IP cores caused a fail.

13. The method as recited in claim 11, further comprising using a device to provide pseudo random patterns to the drive circuit.

14. The method as recited in claim 11, wherein the step of using a device comprises using a linear feedback shift register.

15. The method as recited in claim 14, further comprising not using a Multiple-Input Signature Register to effect the test.
